(19) United States
(12) Patent Application Publication
(10) Pub. No.: US 2018/0195469 A1
(43) Pub. Date: Jul. 12, 2018

(54) ONBOARD FUEL REFORMING USING SOLAR OR ELECTRICAL ENERGY

(71) Applicant: Saudi Arabian Oil Company, Dhahran (SA)

(72) Inventors: Esam Z. Hamad, Dhahran (SA); Christos Kalamaras, Al Khobar (SA); Nehal Jawad Bokhumseen, Al Khobar (SA)

(73) Assignee: Saudi Arabian Oil Company, Dhahran (SA)

(21) Appl. No.: 15/402,498

(22) Filed: Jan. 10, 2017

(51) Int. Cl. F02M 25/12; B60K 13/04; B60K 15/10; F01N 3/20; F02M 26/35; F02M 26/22; C25B 1/04; B01D 53/94

(52) U.S. Cl. CPC F02M 25/12; B60K 13/04; B60K 15/10; F01N 3/208; F02M 26/35; F02M 26/22; F01N 2610/1406; B01D 53/9418; B01D 53/9495; B01D 53/9431; F01N 2570/14; F01N 2610/04; C25B 1/04

(57) ABSTRACT

An operational control system for an internal combustion engine, an internal combustion engine, a vehicle and a method of onboard generation of hydrogen in a vehicle being powered by an internal combustion engine. The operational control system includes a source of electric current, a gas generator with a supply of hydrogen precursor material and one or both of an SCR device and a fuel octane boosting device. The gas generator is configured to convert the contained precursor material into an H₂ gas by operation of solar energy, electrical energy or both being delivered by the source. The SCR device is fluidly cooperative with the gas generator such that a catalyst-activated fluid-permeable medium disposed in an exhaust gas flowpath defined by the SCR device accepts the passage of the exhaust gas through it and at least intermittently receives the H₂ gas from the gas generator to perform catalytic reduction of NOₓ. Likewise, the fuel octane boosting device defines an H₂ gas conduit that is structured to deliver H₂ from the gas generator can be at least intermittently introduced to the internal combustion engine as a way to provide an enhanced energy content to diesel, gasoline or related fuel being combusted therein.

### BACKGROUND

The present disclosure relates generally to a vehicular system for providing the onboard production of hydrogen; and more particularly for the onboard generation of hydrogen for one or both of the treatment of internal combustion engine (ICE) post-ignition emission byproducts and fuel octane rating improvements in ICE operational efficiency.

In an attempt to comply with increasingly stringent air quality standards, ICE manufacturers—typically in the form of vehicular original equipment manufacturers (OEMs)—have turned to emissions treatments in order to control the production of oxides of nitrogen (typically referred to as NOₓ), carbon monoxide (CO), unburned hydrocarbons (HC) and particulate matter (PM). These ICEs are most commonly either spark-ignition (SI) engines or compression-ignition (CI) engines the former of which includes gasoline engines and the latter of which includes both conventional diesel engines as well as gasoline-based CI engines. Of the various forms of emissions mentioned above, NOₓ has received a particularly heightened level of scrutiny of late for its supposed connection to ground-level ozone (i.e., smog).

Known emission treatments have provided a measure of reduction in vehicular tailpipe emissions for NOₓ, as well as for CO and HC. One common form of treatment includes catalytic converters for SI engines. While these devices take advantage the near-stoichiometric consumption of fuel and O₂ levels that are present in such engines, they do not function well for CI engines as the latter's high peak temperature and lean-burn combustion process often leaves high quantities of O₂ in the exhaust gas stream; such elevated O₂ levels are conducive to NOₓ formation. More particularly, when nitrogen (N₂) and oxygen (O₂) are mixed together under high temperatures such as those that take place in an ICE combustion chamber or related engine cylinder, they disassociate into their atomic states to, after a series of chemical reactions, produce NOₓ and other nitrogen-based oxides. As such, for CI engines in general and diesel-based CI engines in particular, two other approaches to reduce NOₓ emissions are used: exhaust gas recirculation (EGR) and selective catalytic reduction (SCR). EGR systems, which also act as heat exchangers, take advantage of the fact that lower temperatures within the combustion chamber significantly lower NO production. One way to achieve this is through the introduction of CO₂-rich exhaust gas into the cylinder. The higher heat content of CO₂ permits it to absorb a significant amount of latent heat in the cylinder, which in turn reduces the local temperature. In addition, the lower oxygen content of the exhaust gas means that fewer NOₓ-producing reactions may take place in the cylinder. With regard to CI engines in general and diesel-based CI engines in particular, the use of EGR is essential to meeting stringent emission level standards. However, EGR systems, in addition to contributing to higher ICE production costs and lower fuel economy (which in turn results in increases in CO₂ and other so-called greenhouse gas emission production that is directly related to fuel usage), are not sufficient as a stand-alone NOₓ-reducing remedy.

This has led OEMs to find other ways to reduce NO emissions, including the use of SCR, where an aqueous solution of urea or a related reductant is injected into the exhaust gas stream in the presence of a catalyst to convert the NO into water and molecular N₂. In one common configuration, an SCR is combined with an EGR, while in another, the SCR provides the sole means for NO reduction. Despite this, the traditional urea-based SCR has shortcomings. For example, the conduit, pumps and urea-storage tank increases system weight and complexity. In addition, the urea supply must be periodically refilled. Furthermore, urea leads to the generation of bisulfate, sulfate, nitrate and related ammonium powder-based compounds. This powder formation is particularly prevalent at low temperatures (i.e., below roughly 140° C.), and has been identified as a source of equipment fouling problems. Furthermore, urea-based SCR systems can be plagued by ammonia slip problem, where some ammonia passes through with the exhaust gases to the ambient air.

Yet a third approach for achieving NO reduction in CI engines is referred to as a NO adsorber or lean NO trap (LNT). This approach operates with an alkaline-based catalyst that forms nitrate-based species during exhaust gas sorption. While the construction is simpler than that of the SCR, its cyclic injection of diesel fuel as a way to regenerate the catalyst as a way to renew active sorption sites results in fuel-use penalties.

Regarding improvements in operation, hydrogen (H₂) can be added to improve ICE combustion efficiency by boosting the octane rating of the fuel. Efficiency is improved via increased power output and knock-free operation of SI engines and gasoline-based CI engines. Known ways of producing H₂ onboard relate to the production of an intermediate synthesis gas (i.e., syngas). Unfortunately, in addition to H₂, syngas contains CO that can interfere with catalytically-active sites by virtue of its strong surface adsorption. Other forms of production, such as through the electrolysis of water or ammonia, often require more energy to generate the H₂ than is available from its use. Moreover, to the extent that the onboard generation of H₂ can be utilized for fuel octane enhancement, the authors of the present disclosure are unaware of any attempt to combine such features with the aforementioned need to reduce NOₓ and other emissions.

### SUMMARY

Despite the shortcomings mentioned above, the authors of the present disclosure have discovered that the onboard generation of H₂ can be done in a way that the produced H₂ can generate more energy than it consumes for use as an enhanced power source for at least some forms of ICE operation, as well as provide an emissions treatment that can—depending on the ICE configuration—be used for NOₓ reduction. According to one embodiment of the present disclosure, an operational control system includes a source of electric current, a gas generator configured to contain a supply of H₂ precursor material, and one or both of an SCR device and a fuel octane boosting device. The gas generator is configured to convert the contained precursor material into an H₂ gas by operation of solar energy, electrical energy or both being delivered by the source. The SCR device is fluidly cooperative with the gas generator such that a catalyst-activated fluid-permeable medium disposed in an exhaust gas flowpath defined by the SCR device accepts the passage of the exhaust gas through it and at least intermittently receives the H₂ gas from the gas generator. Likewise, the fuel octane boosting device defines an H₂ gas conduit that is structured to fluidly cooperate with an ICE such that hydrogen gas from the gas generator can be at least intermittently introduced to the ICE as a way to provide an enhanced energy content to diesel, gasoline or related fuel being combusted therein.

According to another embodiment of the present disclosure, an ICE is disclosed. The ICE includes an oxygen supply, a fuel supply, one or more combustion chambers each of which define a reciprocatingly movable piston therein, an exhaust system and an operational control system. The combustion chamber is fluidly cooperative with the oxygen supply and the fuel supply such that upon combination of an oxygen-bearing reactant and a fuel-bearing reactant in the combustion chamber and subsequent combustion reaction, the expanding combustion-product gases force movement of the piston and then are discharged through the exhaust system as exhaust gas. The operational control system provides for the onboard generation of hydrogen that can be used to effect one or both of exhaust gas treatment and fuel octane rating, and includes a source of electric current, a gas generator that contains a supply of hydrogen precursor material and is configured to convert the hydrogen precursor material into a hydrogen gas by operation of at least one of solar and electrical energy being delivered by the source of electric current, and one or both of an SCR device and a fuel octane boosting device. In situations where the SCR device is present, it is configured to provide at least intermittent treatment of the exhaust gas that passes through the exhaust system, and is fluidly cooperative with the gas generator such that a catalyst-activated fluid-permeable medium disposed in an exhaust gas flowpath defined by the SCR device accepts the passage of the exhaust gas therethrough and at least intermittently receives the hydrogen gas from the gas generator. Likewise, in situations where the fuel octane boosting device is present, it defines a hydrogen gas conduit that is fluidly cooperative with the fuel supply such that hydrogen gas from the gas generator can be at least intermittently introduced to the at least one combustion chamber as a way to provide an enhanced energy content to a fuel being delivered from the fuel supply.

According to still another embodiment of the present disclosure, a vehicle is disclosed. In addition to the ICE discussed in conjunction with the previous embodiment, the vehicle includes a platform comprising a wheeled chassis, a guidance apparatus cooperative with the wheeled chassis and a passenger compartment. The ICE provides propulsive force to the vehicle, while the operational control system provides for the onboard generation of hydrogen that can be used to effect one or both of exhaust gas treatment and fuel octane rating.

According to yet another embodiment of the present disclosure, a method of onboard generation of hydrogen gas in a vehicle being powered by an internal combustion engine is disclosed. The generated hydrogen gas may be used in one or both of a vehicular exhaust gas treatment component and a fuel octane boosting component.

Although the concepts of the present disclosure are described herein with primary reference to certain ICE configurations, it is contemplated that the concepts are not so limited, and as such are applicable to any ICE for transportation-based use.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a simplified view of a hydrogen production system using solar or electrical energy according to an embodiment of the present disclosure;

FIG. 2 illustrates a simplified view of a vehicle showing the inclusion of the hydrogen production system of FIG. 1 according to an embodiment of the present disclosure;

FIG. 3 illustrates the notional placement of the hydrogen production system of FIG. 1 onboard a vehicle, as well as its integration with an exhaust system according to an embodiment of the present disclosure; and

FIG. 4 shows additional details of some of the exhaust gas treatment components that make up the exhaust system of FIG. 3.

### DETAILED DESCRIPTION

Embodiments disclosed herein related to the generation of H₂ gas onboard a vehicle as a way to replace the ammonia that is present in a conventional urea-based SCR process that can be used for emissions treatment in an ICE. Depending on the engine configuration, the produced H₂ may be selectively used to increase the octane number of the fuel being delivered to the engine to increase the engine efficiency or output. In addition, the H₂ gas being generated onboard is done via water or ammonia electrolysis using solar or electrical energy that is already present on the vehicle. In a more particular form, the produced H₂ gas is used to reduce NOₓ emission in the exhaust gas as a replacement of urea in an SCR device.

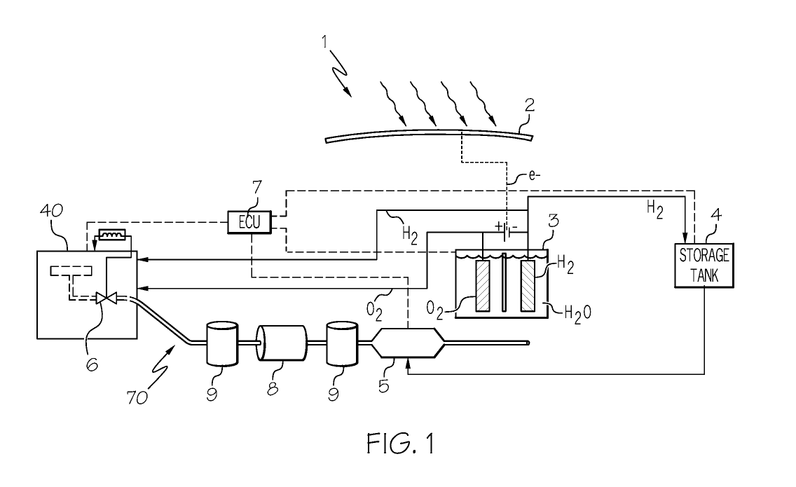

Referring first to FIG. 1, an operational control system 1 is used to provide the selective generation of H₂ for one or both of the after treatment of downstream emission byproducts and upstream fuel octane boosting for an ICE that may be used as a ground-based (i.e., stationary) source of mechanical or electrical (the latter when coupled to a suitable motor) power, as well as an onboard source of motive power for vehicular and related transportation-based platforms as discussed in more detail below. As will be apparent from the context of the present disclosure, such ICEs may be of the aforementioned SI, CI variants, as well as for gasoline compression ignition (GCI) engines. The operational control system 1 includes a source of electric current 2 (presently shown as a solar panel, although other forms, such as battery power, as well as an alternator, when coupled to an ICE in vehicular configurations, may also be used), a gas generator (i.e., reactor) 3 configured to convert the hydrogen precursor material into H₂, an optional tank 4 for containing a electrolytically-generated H₂, and various components (discussed in more detail below) that treat or use the combustion byproducts that flow through an exhaust system (such as vehicular exhaust system 70 as discussed in more detail below). Portions of the operational control system 1 are fluidly coupled along such conduit such that they are functionally integrated into one or more parts of such an exhaust system.

In terms of fuel octane quality, because the fuel octane required for knock-free operation of an SI engine varies widely with load, in all but near full loading operating conditions, the octane rating of the fuel used is under-utilized. Nevertheless, because avoiding knock-free operation is highly desirable, to ensure that the needed octane is present for these full load situations, extra cost and energy expenditure is needed to produce gasoline with a sufficient octane rating. By instead using the operational control system 1 disclosed herein, H₂ (which is an octane rating enhancer) can be used to improve ICE efficiency through multiple factors, such as running at higher compression ratios, as well as physical structure downsize of the engine. Other benefits may also be realized, such as longer particulate filter 8 life for configurations where such a filter 8 is present. In particular, adding H₂ will make the fuel richer in octane, which in turn will enhance the efficiency of the combustion process. This results in less fuel needing to be introduced into the combustion chamber in order to get the same power output per stroke. Another benefit of burning a more rich gas in the combustion chamber is the remaining unburnt excess fuel that then travels to the particulate filter 8 can be used to wash the filter 8 by burning the particulate that is stuck on the filter 8 surface, which will tend to lengthen the life of the filter 8.

Likewise for CI and GCI engines, H₂-assisted octane boosting can be used to modify ignition delay. For example, using the cooling available from the EGR 6 can help promote the relatively low combustion temperature of a GCI engine as a way to reduce both NOₓ and particulate emissions simultaneously. Such enhanced cooling tends to increase the ignition delay period, which in turn may slow the heat release rates that in turn produces lower combustion noise. Changes in cycle efficiency resulting from these low charge temperatures also adjusts heat transfer properties.

As mentioned above, the operational control system 1 may use various types of electric current sources, including (in the case of transportation-based platforms) a vehicle battery, alternator or the like. In a preferred embodiment, the source of electric current is a solar panel 2. Such a solar panel 2 is sized to provide the electrochemical cell of the gas generator 3 with the needed voltage difference (>1.23 V) to start the electrolysis reaction and split water into H₂ and O₂ gas. In one form, the solar panel 2 is made up of a layered series of subcomponents, including numerous individual generally planar battery cells surrounded by one or more of a glass protection plate, an encapsulant used to sealingly affix the cells to the protection plate and a film.

The gas generator 3 receives electric current from the solar panel 2 and is used to produce the H₂ gas that is subsequently delivered to one or more of the devices discussed below that provide fuel octane boosting and exhaust gas after-treatment. The gas generator 3 is made up of one or more electrolysis reactors that in response to an applied electric current decompose a hydrogen-bearing precursor material such as water or ammonia into the H₂ gas. Application of an overpotential from the solar panel 2 (or other source of electric current) to the electrolyte (i.e., water or ammonia) contained within the gas generator 3 will result in an electrical current that overcomes solution activation barriers and related limited self-ionization (especially when the electrolyte is water); this in turn causes electrolysis and the consequent generation of H₂ at the cathode and O₂ at the anode. In water at the negatively charged cathode, a reduction half reaction takes place, where electrons e⁻ from the cathode combine with hydrogen cations to form H₂ gas:

2H+2e⁻→H₂

Likewise, an oxidation half-reaction occurs at the positively-charged anode, generating O₂ gas and donating electrons to the anode to complete the circuit:

2H₂O→O₂+4H+4e⁻

These various half reactions are balanced with a suitable base or acid. Combining either half reaction pair leads to the overall decomposition of water into H₂ and O₂:

2H₂O→2H₂+O₂

The decomposition of pure water into H₂ and O₂ at standard temperature and pressure is not thermodynamically favorable. For example, the standard potential of a water-based electrolytic cell is −1.23 V at 25° C. As such, at least this level of voltage potential must be applied to drive the reaction forward.

The gas generator 3 includes various intakes and outputs for electrical and fluid conduits, as well as for the delivery of H₂ and O₂ produced by the electrolysis. The electrolysis-generated H₂ may be combined with a small amount of warm vapor to be delivered to an air intake manifold and then on to the combustion chamber in order to enhance the octane available from the gasoline, diesel fuel or related fuel during the combustion process. Thus, by producing H₂ onboard and sending it to the ICE, it will increase the octane rating; therefore, allowing an increase in engine efficiency while reducing or eliminating the need to fuel the vehicle 10 with expensive high-octane gasoline. In addition to sending the generated H₂ directly to the ICE, it could also be injected into the ICE indirectly through an EGR 6 that acts as a modified heat exchanger in order to displace some of the intake air being provided to the combustion chamber with inert byproduct (i.e., waste) gases to cool down the combustion process that in turn limits NOₓ formation, especially when the ICE is configured as a CI variant.

The tank 4 may be fluidly coupled to one or more pumps or compressors (not shown) to help store and deliver the H₂ that is being produced in the gas generator 3. The O₂ being produced by the gas generator 3 could be either vented or directed to the ICE to enhance power, while the produced H₂ may be injected directly to the ICE or catalyst, as well as being directed to the optional small storage tank 4 to be used later on. If tank 4 is used, it could in one form a simple container, while in another it may include a sorbent with H₂ affinity as a way to store more gaseous H₂ at a lower pressure. The accumulated H₂ that has evolved from the electrolysis cell of the gas generator 3 and stored in the tank 4 may generate enough pressure within tank 4 to enable it to avoid the need for a separate pump or compressor (not shown); in such circumstance, the tank 4 is deemed within the present context to be self-pressurized. As mentioned herein, the generated H₂ gas for use in a CI engine is directed to one or more of the forms of after-treatment to reduce NOₓ; in situations where there is excess H₂ remaining, it can be either stored in tank 4 for further utilization in after-treatment, or directed to the ICE to decrease ignition delay and improve engine efficiency. On the other hand, in the case of SI engines where NOₓ emissions may already meet air quality standards such that there is no need for reducing the NOₓ level in an after-treatment beyond what is provided by a conventional three-way catalyst, the produced H₂ gas could be sent directly to the ICE for fuel octane enhancement or other such purposes.

The various components or devices of the operational control system 1 that use the generated H₂ to treat or use the combustion byproducts are referred to as the after-treatment portion of the system 1, and include at least one of an SCR 5 for NOₓ reduction and an EGR 6 for fuel octane boosting and NOₓ reduction. All of these components are responsive to an electrical control unit (ECU) 7 through the latter's logic-based construction and operation to perform the following major functions: (a) to generate H₂ gas onboard the vehicle 10, (b) to utilize the produced H₂ by directing it to the SCR 5 for NOₓ reduction in after-treatment and (c) to inject the produced H₂ into the engine cylinders or combining it with the EGR 6 to improve the operational efficiency of the ICE.

Other optional components, such as the aforementioned particulate filter 8 and one or more oxidation catalysts 9, may be fluidly disposed in the conduit that makes up the exhaust system 70. As can be seen, when present, the oxidation catalyst 9 is situated upstream of the SCR 5 and preferably includes one or more canister-based metal or ceramic substrates that promote flow-through of the exhaust gas coming from the exhaust manifold of the ICE. A suitable catalyst (for example, a noble-metal compound or mixture in general and a platinum-group variant in particular) is disposed on the substrate. The oxidation catalyst 9 may be especially useful when used in CI-based engines in general (and for GCI engines in particular) as a way to add O₂ in order to convert CO and unburned hydrocarbons in a separate reaction from the reduction taking place in the SCR 5. In particular, the oxidation catalyst 9 oxidizes the CO and unburned hydrocarbons to form water and CO₂. In such circumstances, the generated H₂ can be delivered to the oxidation catalyst 9 such that the exothermal oxidation of H₂ under lean conditions can be used for reducing the light-off temperature of the oxidation catalysts 9. This in turn helps promote reduced concentrations of the CO and unburned hydrocarbons in the exhaust gas stream of the combustion byproducts.

With particular regard to the SCR 5, by receiving H₂ produced by the gas generator 3, it avoids having to rely upon area or ammonia for its NOₓ reduction. When used as part of the ICE being configured as an SI engine, using H₂ in NOₓ after-treatment with SCR 5 avoids the difficulties associated with urea-based SCR. The construction of the SCR 5 may have some similarity to the oxidation catalyst 9 in that it includes a canister-based flow-through ceramic or metal substrate that is accessed by an inlet that is in fluid communication with the exhaust gas conduit coming from the exhaust manifold of the ICE. For example, the substrate may be made from a porous alumina, silica, zeolite or zirconia core that has a catalytically-active mixture or compound made from one or more base metal components (such as iron, cobalt, copper or vanadium), or from the precious metals of the platinum group, as well as catalysts containing metal oxides (such as iron, cobalt, nickel and molybdenum). In another form, the catalyst may be based on an acidic solid component that includes a metal or metals and their mixtures selected from the group consisting of Group IB, Group IVA, Group VB, Group VIIB, Group VIII or the like. Such construction allows efficient conversion of NOₓ constituents in the exhaust gas when exposed to a reductant such as the generated H₂. Preferably, the SCR 5 is disposed downstream of the oxidation catalyst 9. In one form of operation, the SCR 5 can be made to be responsive to preset such as those associated with ICE coolant temperature, atmospheric pressure, ambient air temperature or the like such that for a given level of these conditions, an expected level of NOₓ production can be predicted. In one form, these preset values and the corresponding NOₓ levels may be stored in a lookup table or similar data structure that may in turn be embodied in the memory of—or accessed by—the ECU 7 that will be discussed in more detail below.

EGR 6 includes both a valve and a heat exchanger that are fluidly disposed in the conduit of the ICE's exhaust system. In one form, the valve is placed in or around the exhaust manifold of the ICE such that a selective amount of combustion byproduct gas flow can be recirculated into the ICE air intake manifold. In one preferred form, the EGR 6 may be temperature-based such that it is responsive to a temperature sensor-based control signal coming from ECU 7 that is discussed in more detail below so that EGR 6 mixes a portion of the exhaust with air received into the intake manifold to regulate the amount of exhaust flow recirculated into the air intake manifold.

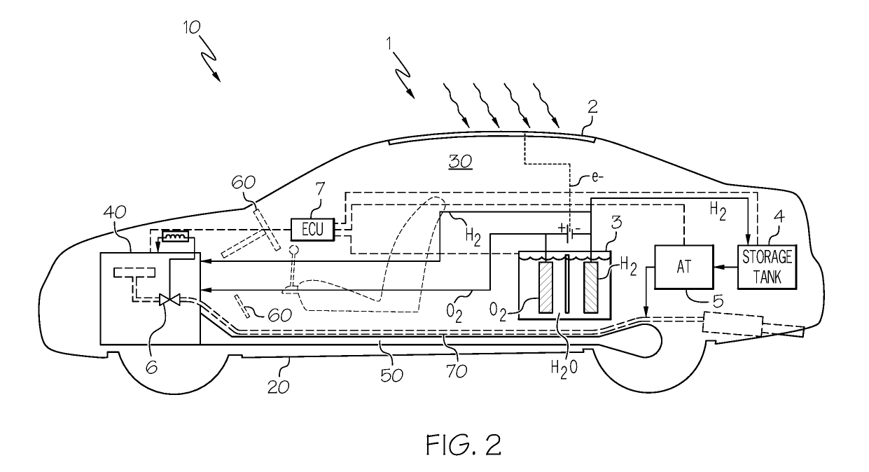

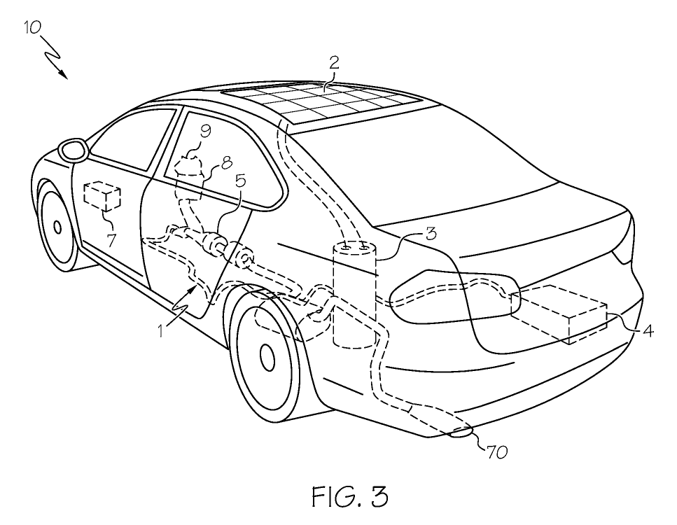

Referring next to FIGS. 2 and 3, a motor vehicle 10 that can use the operational control system 1 is shown. The vehicle 10 includes a wheeled chassis 20 that provides support for a passenger compartment 30, an ICE configured as a motive unit 40 and a transmission 50 (which, along with motive unit 40, is collectively referred to as the drivetrain), guidance apparatus 60 such as steering, accelerator and braking, as well as an exhaust system 70 fluidly coupled to the motive unit 40 in order to process and discharge gaseous byproducts of the combustion that takes place within the motive unit 40. A suspension (not shown) may also be included to provide a dampened, compliant coupling between the wheels and the chassis 20. As can be seen, in one preferred vehicular form, the source of electric current is a solar panel 2 mounted to (or formed as part of) the roof of vehicle 10. Although shown as a single panel, solar panel 2 may also be made up of numerous discrete panels that can be placed at various locations on vehicle 10 and electrically connected in such a way to increase either the voltage or current being delivered to the electrodes of the gas generator 3; either variant is deemed to be within the scope of the present disclosure.

Although shown presently as a sedan, it will be appreciated that vehicle 10 may encompass other architectures as well, including trucks, buses, vans, sport-utility vehicles, crossovers or the like, as well as any other transportation-based platform where an ICE is used to provide motive or other forms of mechanical or electrical power. Each of the various body panels that make up the exterior of vehicle 10 may be secured to the chassis 20 in a known manner through various beams, frames or related structural members (not shown). It will be further appreciated that while the vehicle 10 is discussed in terms of the chassis 20 upon which the other components are mounted, such discussion is equally applicable to traditional body-on-frame vehicular architectures as well as the relatively more recent variant known as unibody construction where the role traditionally played by the frame is replaced by high moment of inertia formations through a monocoque design where parts (for example, outer body panels, roofs or the like) that were not loaded in the more traditional body-on-frame design are now structural members. Regardless of whether vehicle 10 is of a body-on-frame or unibody construction, the chassis 20 forms the basic structural framework. It will be understood by those skilled in the art that unibody (or monocoque) designs tend to blur the lines between the structural chassis and the body, fenders and related coachwork; nevertheless, in either configuration, vehicle 10 includes the fundamental structural features associated with chassis 20, and either variant is deemed to be within the scope of the present disclosure.

The motive unit 40 may be configured as either a gasoline engine as an example of an SI powerplant or a diesel or a gasoline-based example of the CI powerplant. In addition to having ICE components, the motive unit 40 may additionally include electric battery supplements to give it hybrid engine attributes; either version is deemed to be within the scope of the present disclosure as long as at least a portion of the generated power is derived from the ICE. The motive unit 40 may be used in various transportation applications including passenger vehicles 10, commercial vehicles (including heavy trucks or the like), marine, aviation and rail, as well as for various civilian, military, industrial, agricultural, or similar situations where a vehicle 10 needs to be propelled or otherwise powered. In addition to use in vehicles, motive unit 40 may be employed in moveable or stationary generators and related power-generating equipment; such uses are also deemed to be within the scope of the present disclosure.

In one preferred form, the motive unit 40 is a multi-cylinder ICE where such number of cylinders is commonly in four, six or eight cylinder variants. A cylinder block is used to define the space occupied by the cylinders that contain a comparable number of reciprocating pistons. A cylinder head is disposed on an upper portion of the cylinder block and defines a combustion chamber where air and fuel are selectively introduced through camshaft-actuated valves and then mixed and ignited. In the SI version of the ICE, a spark plug is also included to initiate the combustion of the fuel/air mixture, whereas in a CI version of the ICE, no such initiation source is needed. The combustion chamber is fluidly coupled to both an intake (to provide O₂) and a fuel intake (to provide gasoline, diesel fuel or other energy-rich fluid). Conduits including air manifolds and fuel lines (either as port injection, common-rail injection or the like) that may terminate in one or more fuel injectors are used to introduce the respective reactants to the combustion chamber. Upon combustion of the fuel/air mixture in the combustion chamber, the combustion gases force the piston to move along the longitudinal direction of the cylinder such that it imparts movement to a crankshaft that is housed in a crankcase and coupled to the piston through a connecting rod; the coupling converts the reciprocating motion of the piston into rotational movement of the crankshaft that can turn a driveshaft through transmission 30 in order to rotate wheels on one or both of the front and rear axles of vehicle 10. The crankshaft is also rotatably linked to one or more camshafts such that rotational movement in the former is imparted to the latter such that the combustion chamber intake and exhaust valve opening and closing can be timed to coincide with the particular stroke (i.e., intake, compression, ignition/power and exhaust for a four-cycle engine) within a given cycle. Lubrication of the reciprocating and rotating components is achieved through oil that is stored in an oil sump situated in a lower portion of the cylinder block, where an oil pump promotes the circulation of the oil to the piston, crankshaft, connecting rods and other friction-, heat- or wear-prone components within the cylinder block. An exhaust passage is also fluidly coupled to the combustion chamber such that upon the selective opening and closing of the valves that are mounted within the combustion chamber, the gases that form the combustion byproducts may be routed through the exhaust passage and into an exhaust system 70.

The exhaust system 70 is used to treat the combustion byproducts that are formed during the operation of motive unit 40 before being discharged from vehicle 10. Exhaust system 70 includes an exhaust manifold that is fluidly coupled through some of the valves in the combustion chamber to receive the combustion gas byproducts that are formed during the combustion process. Additional conduit is used to route that gas from the exhaust manifold past various sensors (such as a NOₓ sensor, an O₂ sensor and temperature sensors such as an exhaust gas temperature sensor, intermediate temperature sensor or the like), one or more catalytic devices (such as a conventional three-way catalytic converter in ICE configurations employing gasoline SI), light-off converter, exhaust pipes, a muffler and a tailpipe.

The ECU 7 is used to receive data from and provide logic-based instructions to the operational control system 1. As will be appreciated by those skilled in the art, ECU 7 may be a singular unit, or one of a distributed set of units throughout the vehicle 10, depending on the desired degree of integration or autonomy among such control units. Therefore, in one configuration each ECU 7 may be configured to have a more discrete set of operational capabilities associated with a smaller number of component functions, while in anther configuration, ECU 7 may have a more comprehensive capability such that it acts to control a larger number of components; in one example of this latter configuration, ECU 7 may, in addition to regulating the operational control system 1, additionally provide monitoring and control of the motive unit 40 or some other vehicular component. In one form, the ECU 7 is configured as an application-specific integrated circuit (ASIC). All such variants, regardless of the construction and range of functions performed by the ECU 7, are deemed to be within the scope of the present disclosure. Likewise, although shown schematically as being within the passenger compartment 30, it will be appreciated that the ECU 7 is situated in any suitable location within vehicle 10 where access to wiring, harnesses or busses is readily available. ECU 7 is provided with one or more input/output (110), microprocessor (CPU), read-only memory (ROM), random-access memory (RAM), which are respectively connected by a bus to provide connectivity for a logic circuit for the receipt of signal-based data, as well as the sending of commands or related instructions. Various algorithms and related control logic may be stored in the ROM or RAM of ECU 7 in manners known to those skilled in the art. Thus, in one form, CPU can be made to operate on the other components of the operational control system 1 in order to provide monitoring and selective control of exhaust system 70, as well as to regulate the generation of H₂-assisted fuel octane boosting. The control logic may be embodied in a preprogrammed algorithm or related program code that can be operated on by CPU and then conveyed via 110 ports to the operational control system 1 as discussed below. In one form of 110, signals from the various sensors are exchanged with ECU 7. Other such signals, such as an ignition signal (not shown) that indicates whether or not the engine or related motive unit 40 is operational may also be signally provided to ECU 7 for suitable processing by the control logic.

More particularly, the ECU 7 is used to at least partially manage the operation of one or both of the motive unit 40 and the operational control system 1. The ECU 7 may be implemented using model predictive control schemes such as the supervisory model predictive control (SMPC) scheme or its variants, such as multiple-input and multiple-output (MIMO) protocols, where inputs include numerous values associated with the various after-treatment components, sensors (such as exhaust gas temperature sensor, O₂ sensor, NOₓ sensor, SOₓ sensor or the like), estimated values (such as from the lookup tables mentioned above) or the like. In that way, an output voltage associated with the one or more sensed values is received by the ECU 7 and then digitized and compared to a predetermined table, map, matrix or algorithmic value. Based on the differences, outputs indicative of a certain operational condition are generated. These outputs can be used for adjustment in the operational control system 1, where in one exemplary form the outputs may include a predicted NOₓ conversion efficiency that in turn can help determine how much H₂ reductant to introduce into one or more of the operational control system 1 components.

The ECU 7 can be used for the control of the voltage and amperage applied to the anode and cathode of the gas generator 3 that is situated within the electrolyte, as well as for the supply and circulation of the electrolyte and other required materials. In one preferred form, the ECU 7 is connected to receive signals from the various sensors, such as various pressure and temperature sensors as a way to control the various components that make up the operational control system 1, including the SCR 5 and EGR 6 devices. For example, ECU 7 may be preloaded with various parameters (such as the aforementioned coolant temperature, atmospheric pressure and ambient air temperature associated with motive unit 40) into a lookup table that can be included in RAM or ROM. In another form, ECU 7 may include one or more equation- or formula-based algorithms that permit the CPU to generate a suitable logic-based control signal based on inputs from various sensors, while in yet another form, ECU 7 may include both lookup table and algorithm features to promote its monitoring and control functions.

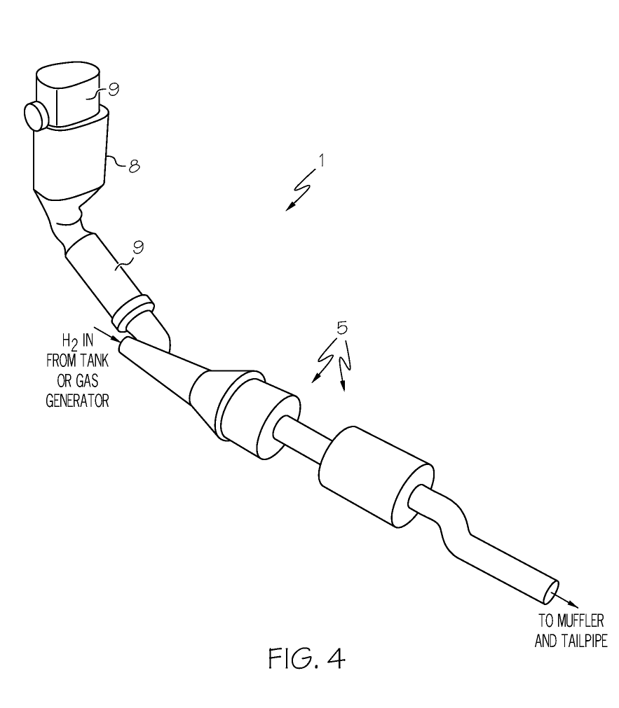

Referring with particularity to FIGS. 3 and 4, a schematic drawing showing the placement of basic elements of the operational control system 1 into vehicle 10 (FIG. 3) and a portion of the exhaust gas flowpath through some of the components of the operational control system 1 (FIG. 4) according to an embodiment of the present disclosure are shown. Specifically, the system 1 generates a source substantially pure H₂ and O₂ that are preferably made through a water electrolysis device in the form of gas generator 3. The ECU 7 provides the logic used to receive operational data (such as through sensors, not shown) on motive unit 40, including engine speed, engine load or the like. Likewise, the ECU 7 may take and process this data as part of providing control logic to the operational control system 1 as a way to govern its operation so that the generated reactants (i.e., the H₂ and O₂) can be fed from the gas generator 3, through suitable metering devices (not shown) to the respective intake of the combustion chamber of motive unit 40. As mentioned above, some of the generated H₂ can be stored for future use through an adsorption device situated in tank 4; such storage is useful in that the H₂ can be saved until needed for fuel octane boosting or other selective reaction or related operations as a reductant. Depending on the level of adsorption of the H₂ with the adsorption device, it may be that sufficient internal H₂ pressures within tank 4 are generated to avoid the need for a pump, compressor or related pressurization device. In other circumstances, such a pressurization device may be included in order to deliver sufficient quantities and pressures of H₂ to one or more of the after-treatment components.

The following two examples give more details for implementing the operational control system 1 and its control infrastructure in SI and CI engines.

### Example I

In one form, vehicle 10 is propelled by an SI engine, and may be configured as a light duty vehicle. Solar panel 2 has an exposed area of 1 square meter (m²), and the solar energy intensity is assumed to be 2200 KWh/m²/year. The efficiency of the solar panel 2 is assumed to be 15%, while the electrolysis reaction conversion efficiency within the gas generator 3 is assumed to be 85%. The amount of H₂ produced on an annual basis (to account for the daily and seasonal variation in solar energy intensity can be determined as follows.

$${H}_{2} O \to {H}_{2} + \frac{1}{2} {O}_{2} Δ G = 237.13 \frac{kJ}{mole {H}_{2} O} \qquad ( 1 )$$

Energy available for H₂ production generated per year by the solar panel is equal to:

$$Es = 2200 \frac{kWh}{{m}^{2} year} \times 3600 \frac{kJ}{kWh} \times 0.15 \times 0.85 \times 1 {m}^{2} = 1.010 \times {10}^{6} \frac{kJ}{year} \qquad ( 2 )$$

The amount of H₂ that could be generated by that energy is equal to:

$$\frac{Es}{Δ G} = 4.26 \times {10}^{3} \frac{mole {H}_{2}}{year} \qquad ( 3 )$$

Assuming that vehicle 10 operates for 12,000 miles per year and that its fuel economy is 30 mpg, and knowing that the average density of gasoline is 0.74 kg/L, then the amount of H₂ needed to reduce NOₓ can be estimated as follows, where the estimated amount of exhaust gases could be determined by:

CH_{y}+(1+y/4)O₂→CO₂+y/2H₂O (4)

where CH_{y} represents the fuel such as gasoline, diesel fuel or the like, where y=1.5 to 2. As such, the air ratio is:

$$Air Ratio = \frac{0.79 {N}_{2}}{0.21 {O}_{2}} \qquad ( 5 )$$

The O₂ will react with parts-per-million (ppm) levels of N₂ that are present in the air that is present in the combustion chamber of the motive unit 40 to produce NOₓ. Considering the previous assumptions, the total moles of exhaust gas when y=2 is equal to 61.1×10⁴ moles/year which—for a NOₓ concentration in the exhaust gas of 100 ppm—means that approximately 61.1 moles/year of NOₓ are being generated. While stoichiometrically a given number of NO moles needs the same number of H₂ moles to be completely treated, in reality NO after-treatments need an excess amount of H₂ gas. As such, the amount of H₂ gas that is needed to treat NOₓ is approximately equal to 488.8 moles/year.

2NO+2H₂→N₂+2H₂O (6)

For other values of y and excess H₂, the required amount of H₂ is given in the following table.

Light Duty (e.g., Passenger Vehicle)

| y = | 1.5 | 1.75 | 2 |
|---|---|---|---|
| No excess of H₂ (moles/year) | 57.4 | 59.4 | 61.1 |
| 3x H₂ moles (moles/year) | 172.2 | 178.2 | 183.3 |
| 8x H₂ moles (moles/year) | 437.6 | 475.2 | 488.8 |

The calculation above demonstrates that using a 1 m² solar panel 2 over vehicle 10 is sufficient to provide an electrochemical cell-based onboard gas generator 3 with enough electricity to generate H₂ to be used in one or both of NOₓ after-treatment and octane boosting for an ICE such as motive unit 40.

### Example II

In another form, vehicle 10 is propelled by a CI engine, and may be configured as a heavy duty vehicle. Repeating the calculations performed in Eqns. (1) through (6) from the previous example above, and assuming a 30 m² solar panel 2, in the same region, for diesel trucks that travel 100,000 miles/year with a fuel economy of 8 mpg, such a vehicle 10 will produce around 1911 moles NO/year, while the solar panel 2 will produce 1.28×10⁵ moles H₂/year. The amount of H₂ needed for after-treatment is 0.15×10⁵ moles, showing again there is enough H₂ being produced onboard to cover the after-treatment needs and then send the rest of H₂ to either the motive unit 40 or to tank 3 for storage. This is shown for other values of y and excess H₂, the amount of H₂ needed is given in the following table.

Heavy Duty (e.g., Truck)

| y = | 1.5 | 1.75 | 2 |
|---|---|---|---|
| No excess of H₂ (moles/year) | 1792 | 1855 | 1911 |
| 3x H₂ moles (moles/year) | 5376 | 5565 | 5733 |
| 8x H₂ moles (moles/year) | 14336 | 14840 | 15288 |

For the purposes of describing and defining features discussed in the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters. It is likewise noted that recitations herein of a component of the present disclosure being “configured” or “programmed” in a particular way, to embody a particular property, or function in a particular manner, are structural recitations, as opposed to recitations of intended use. More specifically, the references herein to the manner in which a component is “programmed” or “configured” denotes an existing physical condition of the component and, as such, is to be taken as a definite recitation of the structural characteristics of the component.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining features discussed in the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

It is noted that terms like “preferably”, “generally” and “typically” are not utilized herein to limit the scope of the claims or to imply that certain features are critical, essential, or even important to the structures or functions disclosed herein. Rather, these terms are merely intended to highlight alternative or additional features that may or may not be utilized in a particular embodiment of the disclosed subject matter. Likewise, it is noted that the terms “substantially” and “approximately” and their variants are utilized herein to represent the inherent degree of uncertainty that may be attributed to any quantitative comparison, value, measurement or other representation. As such, use of these terms represent the degree by which a quantitative representation may vary from a stated reference without resulting in a change in the basic function of the subject matter at issue.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An operational control system comprising:
a source of electric current;
a gas generator configured to convert a hydrogen precursor material contained therein into hydrogen by operation of at least one of solar and electrical energy being delivered by the source of electric current; and
at least one of a selective catalytic reduction device and a fuel octane boosting device, wherein the selective catalytic reduction device is configured to provide at least intermittent treatment of an exhaust gas that is generated as a result of operation of an internal combustion engine, the selective catalytic reduction device being fluidly cooperative with the gas generator such that a catalyst-activated fluid-permeable medium disposed in an exhaust gas flowpath defined by the selective catalytic reduction device accepts the passage of the exhaust gas therethrough and at least intermittently receives the hydrogen from the gas generator, and further wherein the fuel octane boosting device defines a hydrogen conduit that is structured to fluidly cooperate with an internal combustion engine such that the hydrogen from the gas generator can be at least intermittently introduced to an internal combustion engine as a way to provide an enhanced energy content to a fuel being combusted therein.

2. The system of claim 1, wherein the system comprises both of the selective catalytic reduction device and the fuel octane boosting device the latter of which forms at least a part of an exhaust gas recirculation device.

3. The system of claim 1, wherein the gas generator defines a container comprising at least one of water and ammonia therein.

4. The system of claim 3, wherein the gas generator defines a water-based electrolytic reactor that is coupled to the source of electric current such that an electric current generated thereby is delivered to the reactor for the decomposition of water present therein into the hydrogen and oxygen.

5. The system of claim 1, wherein the supply of hydrogen precursor material disposed within the gas generator does not comprise urea.

6. The system of claim 1, wherein the source of electric current generates electric current through a direct conversion of solar energy via solar panel.

7. The system of claim 1, further comprising an engine control unit cooperative with the gas generator to regulate operation of at least one of the selective catalytic reduction device and the fuel octane boosting device.

8. The system of claim 7, wherein the cooperation of the control unit and the fuel octane boosting device is such that the hydrogen is delivered on-demand based on a received signal coming from at least one of the engine control unit and an internal combustion engine.

9. The system of claim 1, further comprising an exhaust gas recirculation device fluidly cooperative with an internal combustion engine exhaust system such that at least a portion of exhaust passing through the exhaust gas recirculation device is delivered to a combustion chamber of an internal combustion engine.

10. The system of claim 1, further comprising a tank fluidly disposed between the gas generator and an internal combustion engine, the tank configured to store at least a portion of the hydrogen generated within the gas generator.

11. The system of claim 10, wherein the tank further comprises a sorbent material disposed therein such that an accumulation of the hydrogen stored in the tank is self-pressurized.

12. An internal combustion engine comprising:
an oxygen supply;
a fuel supply;
at least one combustion chamber defining a movable piston therein, the combustion chamber fluidly cooperative with the oxygen supply and the fuel supply such that upon combination of an oxygen-bearing reactant and a fuel-bearing reactant in the combustion chamber and subsequent combustion reaction therein, expanding gases resulting therefrom force movement of the piston in the combustion chamber after which at least a portion of the expanding gases are discharged through an exhaust system that is fluidly coupled to the at least one combustion chamber; and
an operational control system comprising:
a source of electric current;
a gas generator configured to convert a hydrogen precursor material contained therein into hydrogen by operation of at least one of solar and electrical energy being delivered by the source of electric current; and
at least one of a selective catalytic reduction device and a fuel octane boosting device, wherein the selective catalytic reduction device is configured to provide at least intermittent treatment of an exhaust gas that passes through an exhaust system that is fluidly coupled to the at least one combustion chamber, the selective catalytic reduction device being fluidly cooperative with the gas generator such that a catalyst-activated fluid-permeable medium disposed in an exhaust gas flowpath defined by the selective catalytic reduction device accepts the passage of the exhaust gas therethrough and at least intermittently receives the hydrogen from the gas generator, and further wherein the fuel octane boosting device defines a hydrogen conduit that is fluidly cooperative with the fuel supply such that the hydrogen from the gas generator can be at least intermittently introduced to the at least one combustion chamber as a way to provide an enhanced energy content to a fuel being delivered from the fuel supply.

13. The internal combustion engine of claim 12, wherein the engine is a spark ignition engine.

14. The internal combustion engine of claim 12, wherein the engine is a compression ignition engine.

15. The internal combustion engine of claim 14, wherein the compression ignition engine is a diesel engine or a gasoline direct-injection compression ignition engine.

16. The internal combustion engine of claim 12, wherein the gas generator comprises a water-based electrolytic reactor that is coupled to the source of electric current such that an electric current generated thereby is delivered to the reactor for the decomposition of water present therein into the hydrogen and oxygen.

17. The internal combustion engine of claim 16, wherein the gas generator is further fluidly coupled to the oxygen supply such that at least a portion of the oxygen being generated by the decomposition of water in the reactor is delivered to the oxygen supply.

18. The internal combustion engine of claim 12, further comprising a tank fluidly disposed between the gas generator and the at least one combustion chamber, the tank configured to store at least a portion of the hydrogen generated within the gas generator.

19. The internal combustion engine of claim 18, wherein the tank further comprises a sorbent material disposed therein such that an accumulation of the hydrogen stored in the tank is self-pressurized.

20. A vehicle comprising:
a platform comprising a wheeled chassis, a guidance apparatus cooperative with the wheeled chassis and a passenger compartment;
an internal combustion engine secured to the platform to provide propulsive power thereto, the internal combustion engine comprising:
an oxygen supply;
a fuel supply; and
at least one combustion chamber defining a movable piston therein, the combustion chamber fluidly cooperative with the oxygen supply and the fuel supply such that upon combination of an oxygen-bearing reactant and a fuel-bearing reactant in the combustion chamber and subsequent combustion reaction therein, expanding gases resulting therefrom force movement of the piston in the combustion chamber;
an exhaust system that is fluidly coupled to the at least one combustion chamber such that at least a portion of the expanding gases generated in the combustion chamber are discharged through the exhaust system; and
an operational control system comprising:
a source of electric current;
an onboard gas generator configured to convert a hydrogen precursor material contained therein into hydrogen by operation of at least one of solar and electrical energy being delivered by the source of electric current; and
at least one of a selective catalytic reduction device and a fuel octane boosting device, wherein the selective catalytic reduction device is configured to provide at least intermittent treatment of an exhaust gas that passes through the exhaust system, the selective catalytic reduction device being fluidly cooperative with the gas generator such that a catalyst-activated fluid-permeable medium disposed in an exhaust gas flowpath defined by the selective catalytic reduction device accepts the passage of the exhaust gas therethrough and at least intermittently receives the hydrogen from the gas generator, and further wherein the fuel octane boosting device defines a hydrogen conduit that is fluidly cooperative with the fuel supply such that hydrogen from the gas generator can be at least intermittently introduced to the at least one combustion chamber as a way to provide an enhanced energy content to a fuel being delivered from the fuel supply.

21. The vehicle of claim 20, wherein the engine is a compression ignition engine and the at least one of a selective catalytic reduction device and a fuel octane boosting device comprises both of the selective catalytic reduction device and the fuel octane boosting device the latter of which forms at least a part of an exhaust gas recirculation device that is fluidly coupled to both the exhaust system and the fuel supply such that at least a portion of the exhaust gas is taken from the exhaust system by the exhaust gas recirculation device and injected into the combustion chamber through the fuel supply.

22. The vehicle of claim 20, further comprising a tank fluidly disposed between the gas generator and the internal combustion engine, the tank configured to store at least a portion of the hydrogen generated within the gas generator and comprising a sorbent material disposed therein such that an accumulation of the hydrogen stored in the tank is self-pressurized.

23. A method of onboard generation of hydrogen in a vehicle being powered by an internal combustion engine, the hydrogen for use in at least one of a vehicular exhaust gas treatment component and a fuel octane boosting component, the method comprising:
providing a supply of hydrogen precursor material;
providing electric current through at least one of solar and electrical energy source;
operating an electrolytic gas generator such that the supplied hydrogen precursor material is converted into hydrogen by operation of the source; and
conveying the hydrogen to at least one of a selective catalytic reduction device and a fuel octane boosting device, wherein the selective catalytic reduction device is configured to provide at least intermittent treatment of an exhaust gas that is generated as a result of operation of the internal combustion engine, the selective catalytic reduction device being fluidly cooperative with the gas generator such that a catalyst-activated fluid-permeable medium disposed in an exhaust gas flowpath defined by the selective catalytic reduction device accepts the passage of the exhaust gas therethrough and at least intermittently receives the hydrogen from the gas generator, and further wherein the fuel octane boosting device defines a hydrogen conduit that is structured to fluidly cooperate with an internal combustion engine such that the hydrogen from the gas generator can be at least intermittently introduced to an internal combustion engine as a way to provide an enhanced energy content to a fuel being combusted therein.

24. The method of claim 23, wherein the hydrogen precursor material comprises water, ammonia, or combinations thereof.

25. The method of claim 24, wherein the hydrogen precursor material does not comprise urea.
